(19) United States
(12) Patent Application Publication
(10) Pub. No.: US 2025/0194831 A1
(43) Pub. Date: Jun. 19, 2025

(54) FOOD TRAY

(71) Applicant: Pressed Paperboard Technologies, LLC, Bringham Farms, MI (US)

(72) Inventors: Adam J. Breeden, Findlay, OH (US); Mark A. Poe, Findlay, OH (US); Jason A. Caudill, Findlay, OH (US); Michael A. Weithman, Perrysburg, OH (US); Jacob Taylor, Bringham Farms, MI (US)

(21) Appl. No.: 19/065,515

(22) Filed: Feb. 27, 2025

Related U.S. Application Data
(63) Continuation-in-part of application No. 18/386,891, filed on Nov. 3, 2023.

(51) Int. Cl. A47G 19/03; B31B 50/74; B65D 3/22

(52) U.S. Cl. CPC A47G 19/03; B31B 50/742; B65D 3/22

(57) ABSTRACT

A food tray includes a base wall, side walls, an outer rim, and a fillet. The food tray is formed of two or more layers configured to prevent moisture or other liquid from leaking or permeating into the food tray. In particular, an adhesive layer is included between two layers of the food tray. The polyethylene layer is configured to bond the two layers of the food tray together.

### CROSS-REFERENCE TO RELATED APPLICATIONS

The present application is a continuation-in-part application based on and claiming priority to U.S. patent application Ser. No. 18/386,891, filed Nov. 3, 2023, and entitled “Food Tray,” which is hereby incorporated by reference herein in its entirety.

### TECHNICAL FIELD

The present disclosure relates to food trays for containing food (e.g., meats or produce), and in some embodiments, food trays having flange geometries with beneficial structural support.

### BACKGROUND

Food trays have been developed for storing food and for presenting the food to consumers. For instance, food trays used to store meat (e.g., beef, chicken, pork, etc.) have been proposed. These food trays may include a clear wrap (e.g., plastic wrap) covering the contents of the food tray. The clear wrap may seal or mate at an outer perimeter region of the food tray. Providing adequate strength to the outer perimeter region and designing an outer perimeter region that does not interfere with the sealing/mating of the clear wrap remain challenges.

### SUMMARY

A food tray includes a base wall, side walls, and an outer rim. The side walls extend upward from an outer peripheral region of the base wall. The outer rim extends outward from upper regions of the side walls. The outer rim has a flat region extending upward and outward from the upper regions of the side walls.

A food tray includes a base wall, side walls, an outer rim, and a fillet. The side walls extend upward and outward from an outer region of the base wall along arcs having a first radius. The outer rim extends outward from upper regions of the side walls. The fillet separates the outer rim from the side walls. The fillet has a second radius. The first radius is greater than the second radius.

A food container includes a base, side panels, an outer rim, and a fillet. The side panels extend upward and outward from an outer region of the base along arcs having a first radius. A food storage space is defined between the side panels and above the base. An opening to the food storage space is defined along upper ends of the side panels. The outer rim extends radially outward from the upper ends of the side panels. The outer rim has a first flat panel extending radially outward from the upper ends of the side panels. The outer rim has a second flat panel extending downward from the first flat panel on an opposing side of the first flat panel relative to the upper ends of the side panels. The fillet is disposed between the first flat panel and the side panels. The fillet has a second radius. The first radius is greater than the second radius.

A food tray includes a base wall, a side wall extending up and out from the base wall, a bottom portion of the side wall connecting to the base wall via a first fillet, wherein the side wall extends up and out from the base wall along an arc, a first flat region extending out from a top portion of the side wall, a first end of the first flat region connecting to the top portion of the side wall via a second fillet, wherein the arc of the side wall transitions to the second fillet, and a second flat region extending down from a second end of the first flat region. The base wall includes a first layer and second layer, the first layer and the second layer are coupled together by a first polyethylene layer, and each of the first layer and the second layer include paperboard.

In some cases, the paperboard of the first layer and the second layer includes kraft paperboard.

In some instances, the side wall also includes the first layer and the second layer, coupled together by the first polyethylene layer. The first flat region, and the second flat region can also include the first layer and the second layer, coupled together by the first polyethylene layer.

In various cases, an inner surface of the base wall, facing toward a food storage space of the food tray, is coated with a second polyethylene layer and an outer surface of the base wall, facing away from the food storage space, is coated with a varnish layer.

In various instances, an inner surface of the base wall and the side wall are each coated with a second polyethylene layer and an outer surface the side wall, facing away from the food storage space, is also coated with the varnish layer.

In some cases, the first polyethylene or adhesive layer is approximately 0.0001 inches to approximately 0.0015 inches thick, inclusive, and a ratio of a first thickness of the first layer or the second layer to a second thickness of the first polyethylene or adhesive layer is between approximately 30:1 and approximately 20:1, inclusive.

A food tray includes a unitary tray body that includes a base wall, a side wall extending up and out from the base wall, a rim that includes a first region extending at a first end out from a top portion of the side wall, and a second region extending down from a second end of the first region. The unitary tray body includes a first layer of paperboard and second layer of paperboard, coupled together with a first polyethylene layer.

In some instances, the adhesive layer comprises an aqueous coating applied to a first surface of the first layer and a second surface of the second layer and an adhesive sub-layer between the aqueous coating applied to the first surface of the first layer and the second surface of the second layer.

In some cases, an inner surface of the unitary tray body, facing toward a food storage space of the food tray, is coated with a barrier layer and an outer surface of the unitary tray body, facing away from a food storage space of the food tray, is coated with a varnish layer. In some cases, the varnish layer includes a primer layer and a plurality of coating layers.

A method of manufacturing a food tray comprising forming or providing a first layer that includes paperboard, forming or providing a second layer that includes paperboard, coupling the first layer to the second layer of the base wall using a polyethylene layer, and forming the coupled layers into a base wall, a side wall extending up and out from the base wall, and a rim that includes a first region extending out from a top portion of the side wall and a second region extending down from the first region.

In some cases, the paperboard of the first and second layers includes kraft paperboard.

In some instances, the method includes coating an inner surface of the first layer of the base wall in a second polyethylene layer and coating an outer surface of the second layer of the base wall in a varnish layer.

In various instances, coupling the first layer to the second layer of the base wall using an adhesive layer comprises applying an aqueous coating to a first surface of the first layer and a second surface of the second layer and coupling an adhesive sub-layer to the first surface of the first layer and the second surface of the second layer.

### BRIEF DESCRIPTION OF THE DRAWINGS

FIG. 1 is a top perspective view of a first embodiment of a food tray;

FIG. 2 is a top view of the first embodiment of the food tray;

FIG. 3 is a cross-sectional view of the first embodiment of the food tray taken along line 3-3 in FIG. 2;

FIG. 4 is a cross-sectional view of the first embodiment of the food tray taken along line 4-4 in FIG. 2;

FIG. 5 is a magnified view of area A in FIG. 4;

FIG. 6 is a top perspective view of a second embodiment of a food tray;

FIG. 7 is a top view of the second embodiment of the food tray;

FIG. 8 is a cross-sectional view of the second embodiment of the food tray taken along line 8-8 in FIG. 7;

FIG. 9 is a cross-sectional view of the second embodiment of the food tray taken along line 9-9 in FIG. 7;

FIG. 10 is a magnified view of area B in FIG. 9;

FIG. 11 is a chart comparing the ability of the second embodiment of the food tray to withstand an applied force relative to the ability of an existing design to withstand an applied force;

FIG. 12 is a cross-sectional view of a portion of a food tray, showing layers of the food tray; and

FIG. 13 is a flowchart of a method of making a layered food tray.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

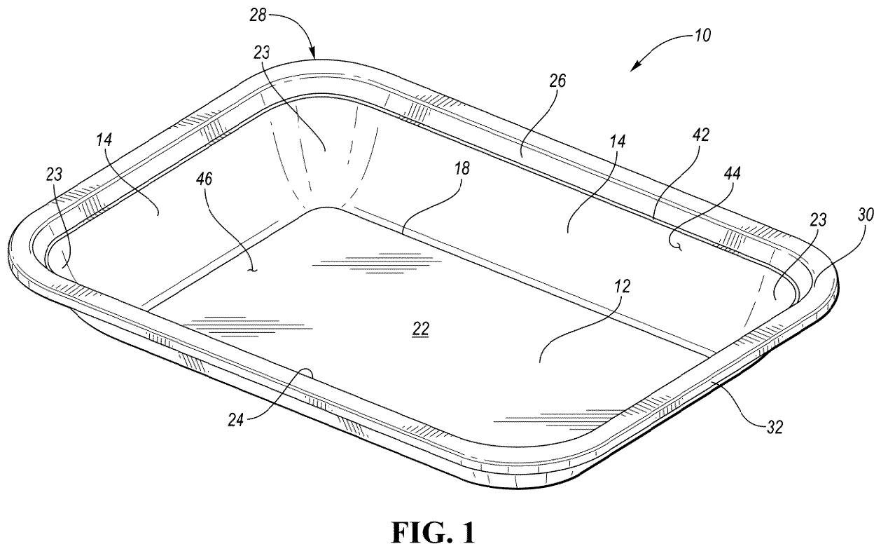

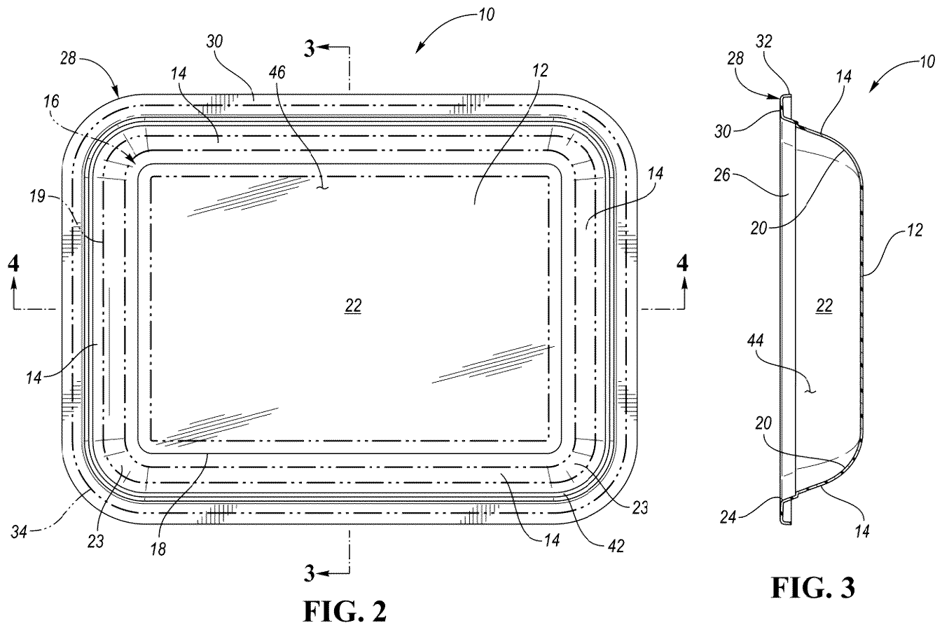

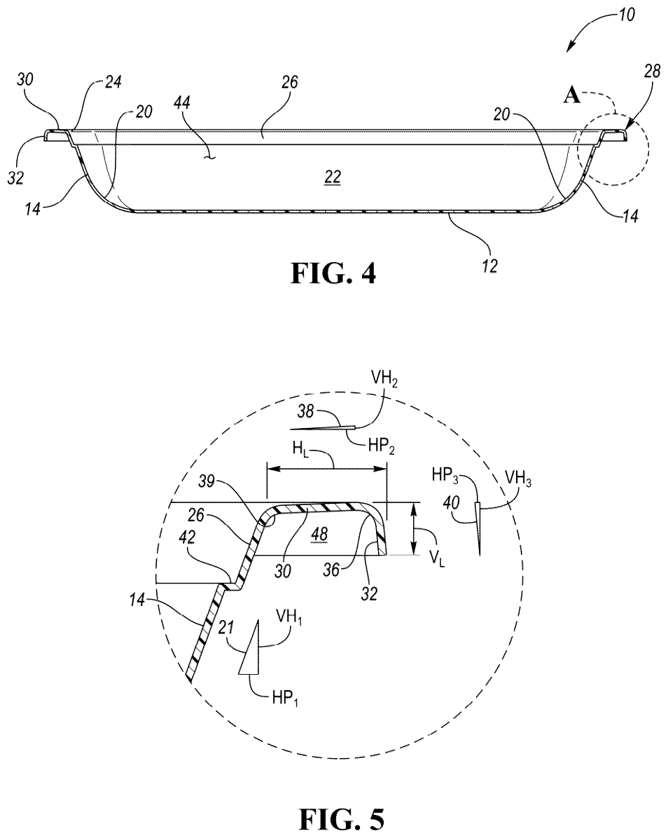

Referring to FIGS. 1-5, a first embodiment of a food tray 10 and the corresponding structure of the food tray 10 are illustrated, with the food tray 10 formed as a unitary tray body in the illustrated example. The food tray 10 may be simply referred to as a tray. The food tray 10 may be constructed of a paperboard layer. Paperboard may refer to a fibrous material that can come from fresh, virgin sources, such as, wood, or from recycled wastepaper. Virgin paper may be made from a high content of wood pulp, for example, 90% wood pulp. The thickness of the paperboard layer may be any of the following values or within an inclusive range between any two of the following values: 0.006 inches, 0.012 inches, 0.018 inches, and 0.024 inches. Any range set forth herein may be an inclusive range.

The inner surface of the food tray 10 may be coated with a polyethylene (PE) resin or a poly substitute. The outer surface of the food tray 10 may be uncoated. The food tray 10 may be sized to contain food (e.g., poultry, beef, fish, produce, etc.). The thickness of the coating layer may be any of the following values or within an inclusive range between any two of the following values: 0.0001 inches, 0.00402 inches, 0.0004 inches, and 0.001 inches.

The food tray 10 may also operate as a food container, and therefore may be referred to as the food container or simply as the container. The food tray 10 may be configured to receive and store items, such as food. The food tray 10 may also be configured to contain and present such items for consumption (e.g., the food tray 10 may have an open top end that contains and/or presents food for transfer onto a plate). The food tray 10 may be configured to engage a cover or lid (not shown), which covers the open top end, when being utilized as a container for storage purposes. Such a cover or lid may be removed to expose the open top end to present the food items for dispensation. The cover or lid may be formed of a clear wrap (e.g., a clear plastic wrap).

The food tray 10 includes a base plate 12. The base plate 12 may be simply referred to as the base. Alternatively, the base plate 12 may be referred to as the base wall or the base panel. The base plate 12 is configured to support food items that are disposed on the food tray 10 along the bottom end of the food tray 10. The food tray 10 includes side walls 14 that extend upward from the base plate 12. The side walls 14 may simply be referred to as the sides. Alternatively, the side walls 14 may be referred to as the side panels. The side walls 14 may extend upward from an outer region or an outer peripheral region 16 of the base plate 12. The side walls 14 may more specifically extend upward from an outer periphery 18 of the base plate 12. The side walls 14 may comprise a single wall that forms a first closed loop 19 that encircles, encompasses, or extends around the base plate 12.

A rounded region or fillet 20 may be positioned between the base plate and the side walls 14. Additional rounded regions or fillets 23 may be positioned between adjacent side walls 14. The rounded regions or fillets 23 may taper as they extend down and toward the base plate 12. Rounded region or fillet 20 and rounded regions or fillets 23 may be concave when viewed internally within a food storage space 22 defined by the food tray 10. Rounded region or fillet 20 and rounded regions or fillets 23 may be convex when viewed externally from an exterior of the food tray 10.

The side walls 14 may extend upward and radially outward from the base plate 12. The base plate 12 may be oriented horizontally and the side walls 14 may extend upward and outward from the base plate 12 at a slope 21 that is greater than 0.5 (e.g., at an angle that is 25° or greater from a horizontal plane or from the base plate 12). In some examples, the slope 21 can be greater than 1 (e.g., at an angle that is 45° or greater from a horizontal plane or from the base plate 12). Slope 21 may refer to a ratio in a change in vertical height VH₁ from a horizontal plane or from the base plate 12 over a corresponding change in a horizontal position HP₁ (e.g., slope 21=VH₁/HP₁).

In one or more embodiments, the side walls 14 may extend upward and outward from the base plate at a slope 21 that ranges between 0.5 (e.g., at an angle that is 25° or approximately 25° from a horizontal plane or from the base plate 12, or that is 25° or approximately 25° from a vertical plane) and 11 (e.g., at an angle that is 85° or approximately is 85° from a horizontal plane or from the base plate 12, or that is 5° or approximately 5° from a vertical plane), inclusive. In some examples, the slope 21 can range between 1 (e.g., at an angle that is 45° or approximately 45° from a horizontal plane or from the base plate 12, or that is 45° or approximately 45° from a vertical plane) and 11 (e.g., at an angle that is 85° or approximately is 85° from a horizontal plane or from the base plate 12, or that is 5° or approximately 5° from a vertical plane), inclusive. Unless otherwise specified or limited, the terms ‘about’ and ‘approximately,’ as used herein with respect to a reference value, refer to variations from the reference value of ±20% or less (e.g., ±15, ±10%, ±5%, etc.), inclusive of the endpoints of the range.

The base plate 12 may be substantially flat. As used herein, substantially flat refers to a flat surface that has no deviations from a perfectly flat plane or has deviations from the perfectly flat plane that are less than a tolerance of 3 millimeters (mm). For example, the base plate 12 may have an allowable tolerance of 3 mm or less, 2 mm or less, 1 mm or less, or 0.5 mm or less, 0.25 mm or less, etc. from a corresponding perfectly flat plane. As used herein, “flat” may indicate a planar feature or a substantially flat feature. As used herein, “substantially flat” refers to a feature that deviates from a reference plane by less than a tolerance of 2 millimeters (mm).

The side walls 14 may be configured to prevent items, such as food items, from slipping or falling off the base plate 12. Stated in other terms, the side walls 14 may be configured to retain items, such as food items, on the base plate 12. The food storage space 22 is defined between the side walls 14 and above the base plate 12. An opening 24 to the food storage space 22 is defined along upper ends or upper regions 26 of the side walls 14. The opening 24 may be covered by a lid (not shown) when the food tray 10 is being utilized as a storage container.

The food tray 10 includes an outer rim 28 that extends outward from the side walls 14. The outer rim 28 may be referred to as an overhanging region or an overhang that extends radially outward from the side walls 14. The outer rim 28 may extend radially outward from the upper ends or the upper regions 26 of the side walls 14. The outer rim 28 has a first flat region 30 that extends upward and outward from the upper ends or the upper regions 26 of the side walls 14. The outer rim 28 also has a second flat region 32 that extends downward and outward from the first flat region 30 on an opposing side of the first flat region 30 relative to the upper ends or the upper regions 26 of the side walls 14. The outer rim 28 may form a second closed loop 34 that encircles, encompasses, or extends around the side walls 14 and the base plate 12.

The first flat region 30 may comprise a first flat panel extending upward and radially outward from the upper ends or the upper regions 26 of the side walls 14, while the second flat region 32 may comprise a second flat panel extending downward and radially outward from the first flat panel. The first flat panel may be an upper panel and may be substantially flat. The second flat panel may be a side panel and may also be substantially flat.

The outer rim 28 may further comprise a rounded region or fillet 36. The first flat region 30 may be separated from the second flat region 32 by the rounded region or fillet 36. The first flat region 30 may extend upward and outward from the upper ends or the upper regions 26 of the side walls 14 at a slope 38 relative to the horizontal or relative to the base plate 12 that is less than one (e.g., at an angle that is 45° or less from a horizontal plane or from the base plate 12). Slope 38 may refer to a ratio in a change in vertical height VH₂ from a horizontal plane or from the base plate 12 over a corresponding change in a horizontal position HP₂ (e.g., slope 38=VH₂/HP₂).

In one or more embodiments, the first flat region 30 may extend upward and outward from the upper ends or the upper regions 26 of the side walls 14 at a slope 38 that ranges between 0 (e.g., at an angle that is 0° or approximately 0° from a horizontal plane or from the base plate 12, or that is 90° or approximately 90° from a vertical plane) and 0.35 (e.g., at an angle that is 20° or approximately 20° from a horizontal plane or from the base plate 12, or that is 70° or approximately 70° from a vertical plane), inclusive. In some examples, the slope 38 can range between 0 (e.g., at an angle that is 0° or approximately 0° from a horizontal plane or from the base plate 12, or that is 90° or approximately 90° from a vertical plane) and 0.1 (e.g., at an angle that is 5° or approximately 5° from a horizontal plane or from the base plate 12, or that is 85° or approximately 85° from a vertical plane), inclusive.

The first flat region 30 may be separated from the upper ends or the upper regions 26 of the side walls 14 by a rounded region or fillet 39. Rounded region or fillet 36 and rounded region or fillet 39 may be concave when viewed from a bottom of the food tray 10. Rounded region or fillet 36 and rounded region or fillet 39 may be convex when viewed from a top of the food tray 10.

The second flat region 32 may extend downward and outward the first flat region 30 at a slope 40 relative to the horizontal or relative to the base plate 12 that is greater than one (e.g., at an angle that is 45° or greater from a horizontal plane). Slope 40 may refer to a ratio in a change in vertical height VH₃ from a horizontal plane or from the base plate 12 over a corresponding change in a horizontal position HP₃ (e.g., slope 40=VH₃/HP₃), with a positive value used for convenience to indicate a negative mathematical slope where a “downward” direction is otherwise specified.

In one or more embodiments, the second flat region 32 may extend downward and outward the first flat region 30 at a slope 40 that ranges between 1.5 (e.g., at an angle that is 55° or approximately 55° from a horizontal plane or from the base plate 12, or that is 35° or approximately 35° from a vertical plane) and 11 (e.g., at an angle that is 85° or approximately 85° from a horizontal plane or from the base plate 12, or that is 5° or approximately 5° from a vertical plane), inclusive. In some examples, the slope 40 can range between 3 (e.g., at an angle that is 75° or approximately 75° from a horizontal plane or from the base plate 12, or that is 15° or approximately 15° from a vertical plane) and 11 (e.g., at an angle that is 85° or approximately 85° from a horizontal plane or from the base plate 12, or that is 5° or approximately 5° from a vertical plane), inclusive. Moving the second flat region 32 outward along slope 40 facilitates loading the second flat region like a spring, which offsets the force applied by the overwrap (e.g., the polyethylene resin or a poly substitute coating), and operates to case separation of the food tray 10 from the stamping die during the manufacturing process.

The outer rim 28 (including the first flat region 30 and the second flat region 32) may have a horizontal length H_{L} and a vertical length V_{L}. The horizontal length H_{L} may be larger than the vertical length V_{L}. A ratio of the horizontal length H_{L} to the vertical length V_{L} may range between 1:1 and 10:1. In some examples, the ratio of the horizontal length H_{L}, to the vertical length V_{L} may range between 2:1 and 5:1. The ratio of the horizontal length H_{L} to the vertical length V_{L} may provide a desired aesthetic appearance to the outer rim 28.

The food tray 10 may further include a horizontally extending ledge 42 that extends within the food storage space 22. More specifically, the horizontally extending ledge 42 may be defined along or by inward or inwardly facing surfaces 44 of the side walls 14. The horizontally extending ledge 42 may be positioned radially inward of the outer rim 28 (including the first flat region 30 and the second flat region 32). The horizontally extending ledge 42 may be positioned radially outward of the base plate 12. The horizontally extending ledge 42 may be positioned below the outer rim 28 (including the first flat region 30 and the second flat region 32). The horizontally extending ledge 42 may be positioned above the base plate 12.

The horizontally extending ledge 42 may be substantially parallel with the base plate 12. More specifically, the horizontally extending ledge 42 may be substantially parallel with an upper surface 46 the base plate 12. As used herein, substantially parallel refers to any incremental angle that is between exactly parallel and 15° or less from exactly parallel (e.g., 12.5° or less from exactly parallel, 10° or less from exactly parallel, or 5° or less from exactly parallel).

The food tray 10 may be manufactured or produced via a stamping process. For example, a blank (e.g., a flat sheet of paper board or other desirable material) may be placed into a stamping die. The stamping die may have a corresponding shape that matches the shape of the food tray 10. To ensure separation of the stamping die from the food tray 10 during the retracting of the stamping die after the food tray 10 has been formed, the food tray 10 may include various shapes or geometric features such as beads, changes in direction of along a surface engaging the die, or other features that operate to facilitate separation of the stamping die from the food tray 10. For example, the horizontally extending ledge 42 corresponds to a change in direction along an external surface of the food tray that may operate to facilitate separation of the stamping die from the food tray 10.

As another example, the side walls 14 and the second flat region 32 extend away from each other in opposing directions and in the downward direction extending away from the first flat region 30. This creates an opening or spreading out effect (e.g., a space 48 defined between the side walls 14 and the second flat region 32 increases in the downward direction extending away from the first flat region 30) that may operate to case separation of the food tray 10 from the stamping die during the manufacturing process. This relationship between the side walls 14 and the second flat region 32 also facilitates loading the second flat region 32 like a spring, which offsets the force applied by the overwrap (e.g., the polyethylene resin or a poly substitute coating).

In one or more embodiments, the combination of HP₁, VH₁, HP₂, VH₂, HP₃, VH₃, H_{L}, and/or V_{L} form a beneficial flange geometry in one or more embodiments. The overall flange geometry adds structural support to the food tray 10 and/or provides a more consistent edge perimeter. The folding of second flat region 32 at fillet 36 is configured in one or more embodiments to eliminate a sharp edge that may otherwise chafe or cut into plastic (e.g., cellophane) applied to the top of the tray to cover or seal it. Side walls 14 are configured to support the overall geometry of the tray. The angle, length, and/or radius of first flat region 30, second flat region 32, fillet 36, and fillet 39 are selected to reinforce the rigidity of food tray 10.

A lid may also be snapped into place over the flange geometry. In one or more embodiments, the flange geometry accommodates placing a plastic material over the tray without chafing or cutting. Also, the second flat region 32 provides support to the food tray 10 without needing additional support in space 48 (e.g., polymer, adhesive, or foam support). The structure of second flat region 32 permit the sharp cut edge of the paper tray to be turndown so that it does not come into contact with the over wrap.

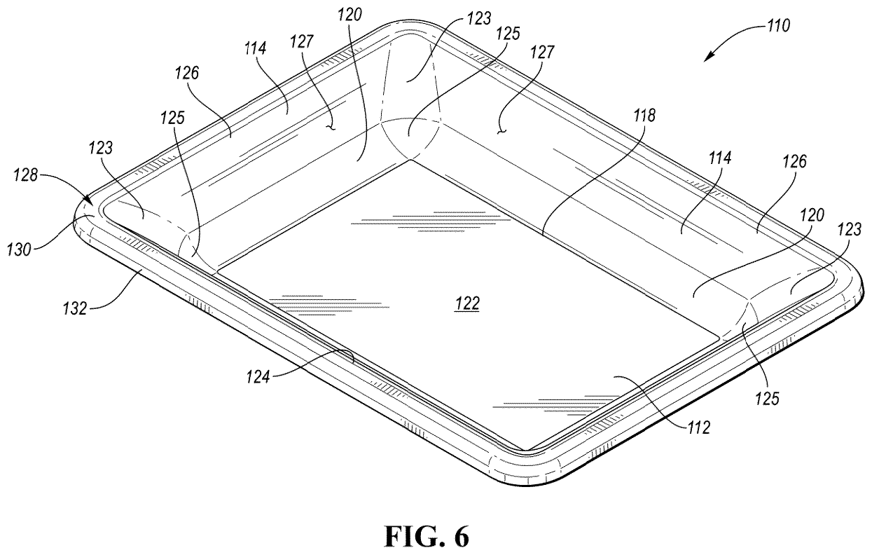

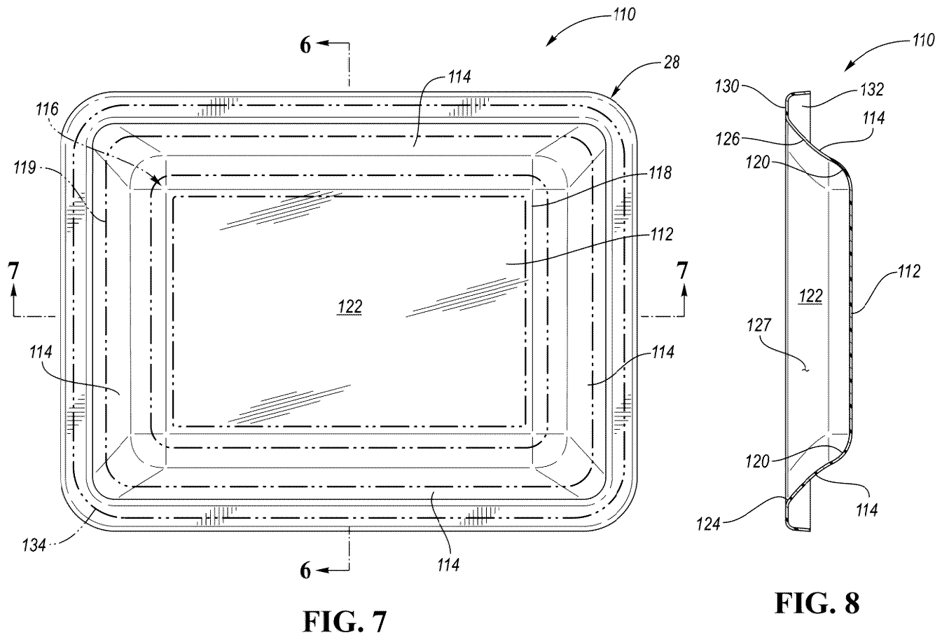

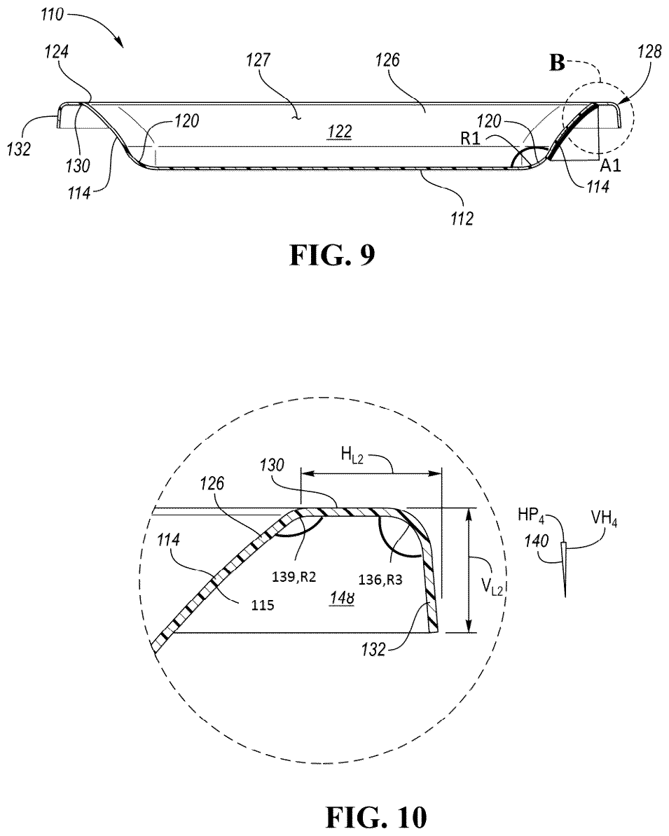

Referring to FIGS. 6-10, a second embodiment of a food tray 110 and the corresponding structure of the food tray 110 are illustrated. The food tray 110 may be simply referred to as a tray. The food tray 110 may be constructed of a paperboard layer. Paperboard may refer to a fibrous material that can come from fresh, virgin sources, such as, wood, or from recycled wastepaper. Virgin paper may be made from a high content of wood pulp, for example, 90% wood pulp. The thickness of the paperboard layer may be any of the following values or within an inclusive range between any two of the following values: 0.006 inches, 0.012 inches, 0.018 inches, and 0.024 inches.

The inner surface of the food tray 110 may be coated with a polyethylene (PE) resin or a poly substitute. The outer surface of the food tray 110 may be uncoated. The food tray 110 may be sized to contain food (e.g., poultry, beef, fish, produce, etc.). The thickness of the coating layer may be any of the following values or within an inclusive range between any two of the following values: 0.0001 inches, 0.00402 inches, 0.0004 inches, and 0.001 inches.

The food tray 110 may also operate as a food container, and therefore may be referred to as the food container or simply as the container. The food tray 110 may be configured to receive and store items, such as food. The food tray 110 may also be configured to contain and present such items for consumption (e.g., the food tray 110 may have an open top end that contains and/or presents food for transfer onto a plate). The food tray 110 may be configured to engage a cover or lid (not shown), which covers the open top end, when being utilized as a container for storage purposes. Such a cover or lid may be removed to expose the open top end to present the food items for dispensation. The cover or lid may be formed of a clear wrap (E.g., a clear plastic wrap).

The food tray 110 includes a base plate 112. The base plate 112 may be simply referred to as the base. Alternatively, the base plate 112 may be referred to as the base wall or the base panel. The base plate 112 is configured to support food items that are disposed on the food tray 110 along the bottom end of the food tray 10. The food tray 110 includes side walls 114 that extend upward from the base plate 112. The side walls 114 may simply be referred to as the sides. Alternatively, the side walls 114 may be referred to as the side panels. The side walls 114 may extend upward from an outer region or an outer peripheral region 116 of the base plate 112. The side walls 114 may more specifically extend upward from an outer periphery 118 of the base plate 112. The side walls 114 may comprise a single wall that forms a first closed loop 119 that encircles, encompasses, or extends around the base plate 112.

A rounded region or fillet 120 may be positioned between the base plate 112 and the side walls 114. Additional rounded regions or fillets 123 may be positioned between adjacent side walls 114. The rounded regions or fillets 123 may also intersect the rounded region or fillet 120 forming intersecting regions 125. The intersecting regions 125 may taper as they extend down and toward the base plate 112. The rounded regions or fillets 123 may expand as they extend down and toward the intersecting regions 125. Rounded regions or fillets 123 and intersecting regions 125 may be concave when viewed internally within a food storage space 122 defined by the food tray 110. Rounded regions or fillets 123 and the intersecting regions 125 may be convex when viewed externally from an exterior of the food tray 110.

The side walls 114 may extend upward and radially outward from the base plate 112. The base plate 112 may be oriented horizontally and the side walls 114 may extend upward and outward from the base plate 112. More specifically, the side walls 114 may extend upward and outward from the rounded region or fillet 120 having a first radius R1 along arcs 115 or curves having an arc radius A₁. In one or more embodiments, the arcs 115 or curves of the side walls 114 may form a section of a circle having the arc radius A₁. The arcs 115 or curves of the side walls 114 may be convex when viewed internally within the food storage space 122 defined by the food tray 110. The arcs 115 or curves of the side walls 114 may be concave when viewed externally from an exterior of the food tray 110. The arc radius A₁ adds rigidity to the food tray 110 and facilitates a reduction in deflection of the side walls 114 in response to forces acting on the side walls 114.

The base plate 112 may be substantially flat. For example, the base plate 112 may have an allowable tolerance of 2 millimeters (mm) or less, 1 mm or less, or 0.5 mm or less, 0.25 mm or less, etc. from a corresponding perfectly flat plane.

The side walls 114 may be configured to prevent items, such as food items, from slipping or falling off the base plate 112. Stated in other terms, the side walls 114 may be configured to retain items, such as food items, on the base plate 112. The food storage space 122 is defined between the side walls 114 and above the base plate 112. An opening 124 to the food storage space 122 is defined along upper ends or upper regions 126 of the side walls 114. The opening 124 may be covered by a lid (not shown) when the food tray 110 is being utilized as a storage container. The food storage space 122 may more specifically be defined between internal surfaces 127 of the side walls 114 and above the base plate 112. The internal surfaces 127 of the side walls 114 are convex due to the arcs 115 or curves of the side walls 114 (e.g., the arcs 115 or curves of the side walls 114 having an arc radius A₁ as illustrated).

The food tray 110 includes an outer rim 128 that extends outward from the side walls 114. The outer rim 128 may be referred to as an overhanging region or an overhang that extends radially outward from the side walls 114. The outer rim 128 may extend radially outward from the upper ends or the upper regions 126 of the side walls 114, relative to a reference axis extending perpendicularly through a centroid of the base plate 112. The outer rim 128 has a first flat region 130 that extends outward from the upper ends or the upper regions 126 of the side walls 114. The outer rim 128 also has a second flat region 132 that extends downward and outward from the first flat region 130 on an opposing side of the first flat reratiogion 130 relative to the upper ends or the upper regions 126 of the side walls 114. The outer rim 128 may form a second closed loop 134 that encircles, encompasses, or extends around the side walls 114 and the base plate 112.

The first flat region 130 may comprise a first flat panel extending radially outward from the upper ends or the upper regions 126 of the side walls 114, while the second flat region 132 may comprise a second flat panel extending downward and radially outward from the first flat panel. The first flat panel may be an upper panel and may be substantially flat. The second flat panel may be a side panel and may also be substantially flat. For example, the first and second flat panels comprising the first flat region 130 and the second flat region 132, respectively, may have an allowable tolerance of 2 millimeters (mm) or less, 1 mm or less, or 0.5 mm or less, 0.25 mm or less, etc. from a corresponding perfectly flat plane.

The outer rim 128 may further comprise a rounded region or fillet 136. The first flat region 130 may be separated from the second flat region 132 by the rounded region or fillet 136. Rounded region or fillet 136 may have a radius R₃. More specifically, rounded region or fillet 136 may form a section of a circle having radius R₃. The first flat region 130 may extend outward from the upper ends or the upper regions 126 of the side walls 114 along a substantially horizontal orientation. Substantially horizontal may refer to any incremental angle that is between exactly horizontal and 5° from exactly horizontal. The first flat region 130 may also be substantially parallel with the base plate 112.

The first flat region 130 may be separated from the upper ends or the upper regions 126 of the side walls 114 by a rounded region or fillet 139. Rounded region or fillet 139 may have a radius R₂. More specifically, rounded region or fillet 139 may form a section of a circle having radius R₂. Rounded region or fillet 136 and rounded region or fillet 139 may each be concave when viewed from a bottom of the food tray 110. Rounded region or fillet 136 and rounded region or fillet 139 may each be convex when viewed from a top of the food tray 110. As previously stated, the side walls 114 may extend upward and outward from the rounded region or fillet 120 along arcs 115 or curves having an arc radius A₁. Fillet 139 is disposed on an opposite end of the side walls 114 and the corresponding arcs 115 relative to fillet 120. Therefore, the side walls 114 and corresponding arcs, having an arc radius A₁, are disposed and extend between, fillet 120 and fillet 139.

The second flat region 132 may extend downward and outward the first flat region 130 at a slope 140 relative to the horizontal or relative to the base plate 112 that is greater than one (e.g., at an angle that is 45° or greater from a horizontal plane). Slope 140 may refer to a ratio in a change in vertical height VH₄ from a horizontal plane or from the base plate 112 over a corresponding change in a horizontal position HP₄ (e.g., slope 140=VH₄/HP₄). Slope 140 facilitates loading the second flat region 132 like a spring, which offsets the force applied by the overwrap (e.g., the polyethylene resin or a poly substitute coating) and operates to case separation of the food tray 110 from the stamping die during the manufacturing process.

In one or more embodiments, the second flat region 132 may extend downward and outward the first flat region 130 at a slope 140 that ranges between 1.5 (e.g., at an angle that is 55° or approximately 55° from a horizontal plane or from the base plate 12, or that is 35° or approximately 35° from a vertical plane) and 11 (e.g., at an angle that is 85° or approximately 85° from a horizontal plane or from the base plate 12, or that is 5° or approximately 5° from a vertical plane), inclusive. In some examples, the slope 140 can range between 3 (e.g., at an angle that is 75° or approximately 75° from a horizontal plane or from the base plate 12, or that is 15° or approximately 15° from a vertical plane) and 11 (e.g., at an angle that is 85° or approximately 85° from a horizontal plane or from the base plate 12, or that is 5° or approximately 5° from a vertical plane), inclusive.

The outer rim 128 (including the first flat region 130 and the second flat region 132) may have a horizontal length H_{L2} and a vertical length V_{L2}. A ratio of the horizontal length H_{L2} to the vertical length V_{L2} may range between 1:4 and 10:1, inclusive. In some examples, the ratio of horizontal length H_{L2} to the vertical length V_{L2} may range between 1:2 and 2:1, inclusive.

A ratio of arc radius A₁ over radius R₂ (A₁/R₂) is greater than one. In one or more embodiments, the ratio of arc radius A₁ over radius R₂ (A₁/R₂) may range between 4 and 20. Such a ratio (A₁/R₂) facilitates a gradual opening of the side wall 114 along the top of the food tray 110 while also facilitating a quicker transition or a sharper transition from the side walls 114 to the first flat region 130 of the outer rim 128. The transition between radius A₁ and radius R₂ is designed to be as subtle as possible so that a hinge point is not created. Such a hinge point would facilitate a non-desired increase in deflection when a force is applied to the second flat region of 132.

A ratio of radius R₃ over radius R₂ (R₃/R₂) is less than one. In one or more embodiments, the ratio of radius R₃ over radius R₂ (R₃/R₂) may range between 0.1 and 1, inclusive. In some examples the ratio of radius R₃ over radius R₂ (R₃/R₂) may range between 0.5 and 1. Such a ratio (R₃/R₂) facilitates a transition from the first flat region 130 of the outer rim 128 to the second flat region 132 of the outer rim 128 that is sufficiently quick or sharp but not as quick or sharp as transition from the side walls 114 to the first flat region 130 of the outer rim 128. This arrangement can help to ensure that the upper edge of the outer rim 128 (e.g., the outward facing convex surface along fillet 139), which is more likely to come into contact with a user, is more rounded and less sharp than the outward facing convex surface along fillet 136 where a sharper transition from the side walls 114 to the first flat region 130 may be desirable. The sharper transition allows the second flat region of 132 to be closer to perpendicular relative to the first flat region 130. Decreasing radius R₃ reduces stress and potential unwanted deformation of the food tray during manufacturing.

The food tray 110 may be manufactured or produced via a stamping process. For example, a blank (e.g., a flat sheet of paper board or other desirable material) may be placed into a stamping die. The stamping die may have a corresponding shape that matches the shape of the food tray 110. To ensure separation of the stamping die from the food tray 110 during the retracting of the stamping die after the food tray 110 has been formed, the food tray 110 may include various shapes or geometric features such as beads, changes in direction of along a surface engaging the die, or other features that operate to facilitate separation of the stamping die from the food tray 110.

For example, the side walls 114 and the second flat region 132 extend away from each other in opposing directions and in the downward direction extending away from the first flat region 130. This creates an opening or spreading out effect (e.g., a space 148 defined between the side walls 114 and the second flat region 132 increases in the downward direction extending away from the first flat region 130) that may operate to facilitate separation of the stamping die from the food tray 110.

In one or more embodiments, the combination of HP₄, VH₄, A₁, R₂, R₃, H_{L2}, and/or V_{L2} form a beneficial flange geometry in one or more embodiments. The overall flange geometry adds structural support to the food tray 110 and/or provides a more consistent edge perimeter. The folding of second flat region 132 at fillet 136 is configured in one or more embodiments to eliminate a sharp edge that may otherwise chafe or cut into plastic (e.g., cellophane) applied to the top of the tray to cover or seal it.

A lid may also be snapped into place over the flange geometry. In one or more embodiments, the flange geometry accommodates placing a plastic material over the tray without chafing or cutting. Also, the second flat region 132 provides support to the food tray 110 without needing additional support in space 148 (e.g., polymer, adhesive, or foam support). The distance between the side walls 114 and second flat region 132 within space 148 is minimized without compromising the benefits of the relationship between arc radius A₁ and radius R₂. Horizontal length H_{L2} and the space 148 are design to be as short as possible so that torsional loads are minimized without compromising the benefits of the relationship between arc radius A₁ and radius R₂.

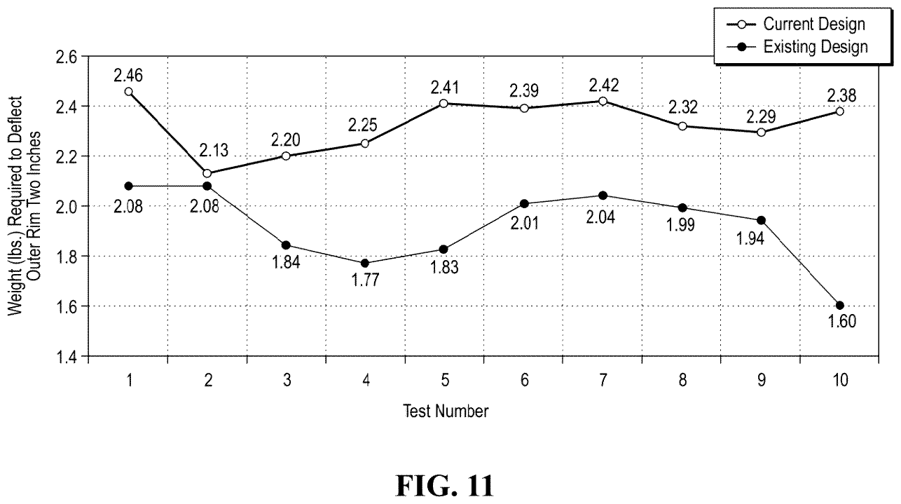

Referring to FIG. 11, a chart that compares the ability of the second embodiment of the food tray 110 (labelled as “Current Design”) to withstand an applied force relative to the ability of an existing design (labelled as “Existing Design”) to withstand an applied force is illustrated. Several tests were conducted on the current design and the existing design. Each test included applying a downward force along the outer rim of the current design (outer rim 128) and the outer rim of the existing design. In total, ten tests were conducted on both the current design and the existing design. The tests are labelled as test numbers 1-10 on the X-axis.

The Y-axis depicts the force (lbs.) that was applied during each test that resulting in deflecting the outer rim of the current design and the outer rim of the existing design a distance of two inches. The values of the forces that resulted in deflecting outer rim of the current design two inches are greater than the values of the forces that resulted in deflecting outer rim of the existing design two inches. The forces required to deflect the outer rim of the current design ranged between 2.13 and 2.46 lbs. over the ten tests with an average force of 2.33 lbs. The forces required to deflect the outer rim of the existing design ranged between 1.60 and 2.08 lbs. over the ten tests with an average force of 1.92 lbs. These results indicate that a larger force is required to deflect the outer rim of the current design relative the force required to deflect the outer rim of the existing design. This further indicates that the ability of the current design to withstand an applied force is greater than the ability of the existing design to withstand an applied force.

In some examples, it may be desirable to provide a food tray that is capable of preventing moisture or other liquid from penetrating through the food tray. In other words, it may be desirable to prevent moisture or other liquid from leaking out of the food tray from food contained within the food tray or prevent moisture or other liquid from permeating into the food tray and contaminating food contained within the food tray.

In view of the issues above, some embodiments of the disclosure provide a food tray capable of preventing (or significantly impeding) moisture or other liquid from penetrating or permeating through the food tray. For example, some embodiments can provide one or more layers or coatings of polyethylene, a poly substitute, or a varnish, or other coating or layer capable of preventing moisture or other liquid from penetrating through the food tray. In various cases, these layers or coatings could be added to the food tray during a lamination process or overcoating process. Further, in some examples, particular coatings can be used to adhere adjacent layers together (e.g., adjacent layers of paperboard) for further improvement of tray performance.

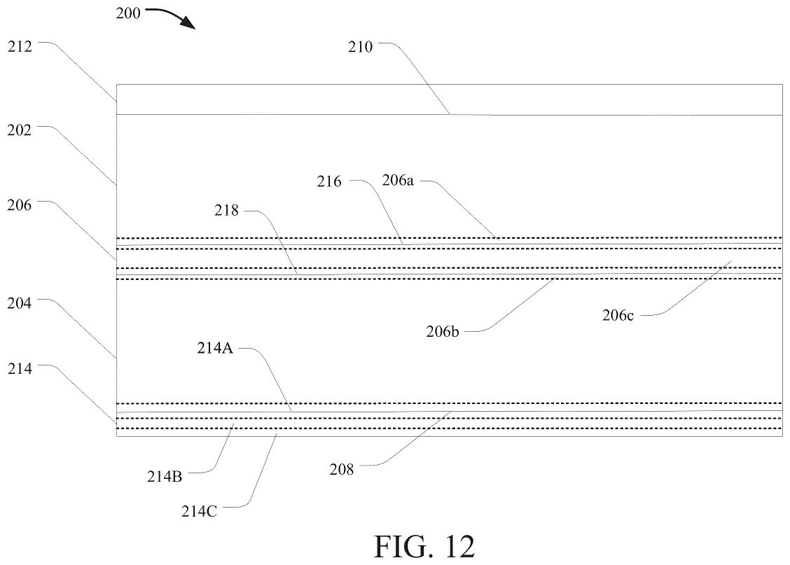

Turning to FIG. 12, a tray can include a layered wall construction 200. The food tray could be food tray 10, food tray 110, or another tray. The layered wall construction 200 could be used to form one or more selected portions of the food tray or the entire food tray. For example, one or more of the base plate, the side walls, the fillets, the flat regions, or the like of the food tray could be formed of the layered wall construction 200 as shown, or a sub-set of the layers thereof. Each of the layers of the layered wall construction 200 as illustrated can in some cases include sub-layers (e.g., could be a single, uniform layer, or could include two or more sub-layers, including as illustrated with dotted lines in FIG. 12).

In various cases, the food tray could be formed of a first layer 202 and a second layer 204. The first layer 202 and the second layer 204 could be formed from paperboard as previously defined above. In particular, the paperboard could be kraft paperboard (i.e., paperboard produced with the kraft or sulfate process), including solid unbleached sulfate kraft liner board (generally known as “SUS”). In some cases, the kraft paperboard could be 55 #Kraft Liner Board. In some cases, the first layer 202 and the second layer 204 could be formed from corrugated fiberboard, chipboard, multiple layers of paper, cardboard, solid bleached sulfate, or folding box board, or the like.

With conventional approaches to food tray design, paperboard may not provide sufficient strength or durability, and plastic materials are correspondingly widely used for these and similar applications. Further, kraft paperboard in particular may be disfavored for tray design, being typically used instead for larger and thicker box structures (e.g., for bulk transport), the size and economics of which can support the inclusion of substantial corrugated or fluted support structures to reinforce the paperboard material. However, it has been discovered that by using paperboard in layers as disclosed herein—e.g., as the first layer 202 and the second layer 204-a tray can be collectively made resistant to tearing and able to easily maintain the desired shape and structure (e.g., in particular, as applied relative to the various beneficial wall structures detailed herein). Further, the disclosed approaches can be used in particular with kraft paperboard, with combinations of layering and one or more coatings providing both sufficient strength and appropriate surface (or other) characteristics for food applications.

The first layer 202 and the second layer 204 can be coupled together using an optional third layer 206, which can in some cases help to adhere or bond the first and second layers 202, 204 together with relative high uniformity and durability. The third layer 206 can be an adhesive layer 206. The adhesive layer 206 can be formed from a first polyethylene layer 206, including a polyethylene (PE) resin or a poly substitute. In some cases, the adhesive layer 206 could be formed from a hot glue, a compostable or biodegradable coating, polyurethane, a plant-based liquid glue, gelatin, or the like.

In some cases, third layer 206 can be applied as multiple sub-layers, as further detailed below. For example, as shown with dotted lines in FIG. 12, one or more of sub-layers 206A, 206B, 206C can be included. In some cases, one or more sub-layers may be one or more aqueous coating sub-layers. For example, as shown, the sub-layer 206A and 206B can be one or more aqueous coating layers, as defined below, with an adhesive sub-layer subsequently applied for sub-layer 206C (e.g., as one or more polyethylene layers, one or more hot glue layers, one or more compostable or biodegradable coating layers, one or more polyurethane layers, one or more plant-based liquid glue layers, one or more gelatin layers, etc.). In this regard, for example, the one or more aqueous sub-layers 206A and 206B can be applied so as to penetrate the layers 202 and 204 and leave at least some of the surface 216 of the first layer 202 and at least some of surface 218 of the second layer 204 exposed to receive the subsequent sub-layer 206C. The adhesive layer 206 or adhesive sub-layer 206c could then be used to laminate or bond the first layer 202 and the second layer 204 together.

In some cases, an optional fourth layer 212 can be formed on an inner surface 210 of the food tray. The fourth layer 212 can be a second polyethylene layer 212, e.g., including a polyethylene (PE) resin or a poly substitute similar to the first polyethylene layer 206. In some cases, the second polyethylene layer 212 can also be formed of LDPE or an LDPE substitute and be capable of contacting food contained within the food tray. In some cases, the optional fourth layer could be formed from a compostable or biodegradable coating, polyurethane, a plant-based liquid glue, gelatin, an aqueous coating, or other material capable of contacting food, or the like. The fourth layer 212 can be used to help prevent moisture or liquid from leaking out of the food tray or permeating into the food tray, serving in particular as a barrier between food within the food tray and the first layer 202. In particular, in the illustrated example, the outer surface 208 is the surface of the second layer 204 that is located on or toward the exterior of the food tray while the inner surface 210 refers to the surface of the first layer 202 that is located on or toward the interior of the food tray, although other configurations are possible (e.g., on trays with different numbers or other different configurations of layers).

In various instances, an optional fifth layer 214 can be formed on the outer surface 208 of the food tray. The optional fifth layer 214 could be a varnish layer 214 or a third polyethylene layer. The varnish layer 214 could be an aqueous coating or aqueous varnish, a compostable or biodegradable coating, polyurethane, LDPE, or an LDPE substitute, or the like. An aqueous coating or aqueous varnish is a water-based coating and can include a gloss, matte, satin, soft touch, or other type of coating. Similar to the first polyethylene layer 206 and the second polyethylene layer 212, the varnish layer 214 can be used to prevent or substantially prevent moisture or liquid from leaking out of the food tray or permeating into the food tray.

In some cases, a varnish layer can be applied as multiple sub-layers, as further detailed below. For example, as shown with dotted lines in FIG. 12, one or more of sub-layers 214A, 214B, 214C can be included. In some cases, one or more sub-layers may be a primer layer. For example, as shown, the sub-layer 214A can be a primer layer, with a different coatings subsequently applied for one or more of the sub-layers 214B or 214C (e.g., as one or more polyethylene layers, aqueous coating layers, or the like). In this regard, for example, the primer sub-layer 214A can be applied so as to penetrate the layer 204 and leave at least some of the outer surface 208 of the second layer 204 exposed to receive the subsequent sub-layer 214B.

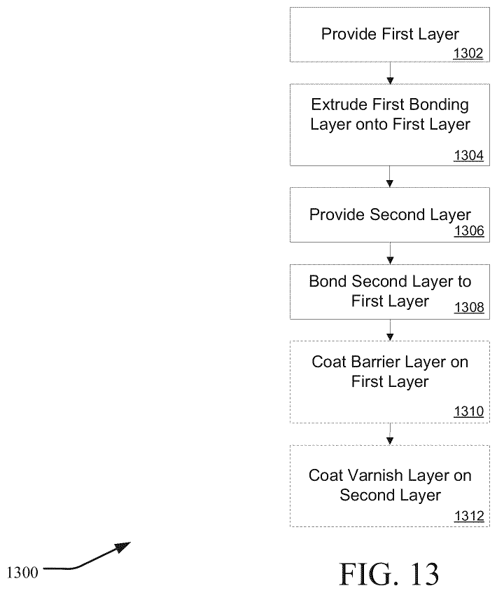

FIG. 13 illustrates a method 1300 for forming a food tray comprising two or more layers (e.g., as shown in FIG. 12, with corresponding example components in discussion below). The method can include, at block 1302 (e.g., generally, a manual or a machine operation), forming or providing a first layer 202 of a food tray. The first layer 202 of the food tray could be suitable to form one or more portions of the food tray including one or more of the base plate, the side walls, the fillets, the flat regions, or the like of the food tray. As discussed above, the first layer 202 could be paperboard, including kraft paperboard. The thickness of the first layer 202 may be any of the following values or within an inclusive range between any two of the following values: 0.006 inches, 0.012 inches, 0.018 inches, and 0.024 inches.

The method 1300 at block 1304 can include extruding or coating a first bonding layer (e.g., the first adhesive layer 206, the first polyethylene layer 206) on the first layer 202. The bonding layer, e.g., first polyethylene layer 206, first adhesive layer 206 can be used to substantially coat (i.e., coat an entirety, or approximately 90% or more of an exposed surface area) of the first layer 202 or one or more selected portions of the first layer 202. The one or more selected portions of the first layer 202 could include locations where one or more of the one or more of the base plate, the side walls, the fillets, the flat regions, or the like of the food tray are formed. The first polyethylene layer 206 could be an LDPE layer. The thickness of the bonding layer may be any of the following values or within an inclusive range between any two of the following values: 0.0001 inches, 0.0004 inches, and 0.001 inches. For paperboard constructions as disclosed, and for kraft paperboard in particular, the range is preferably between approximately 0.0001 inches and approximately 0.0015 inches, to balance appropriate adhesion (as discussed below) with ease of manufacturing, for optimized durability of food tray products.

The method 1300 can include, at block 1306, forming or providing a second layer 204 of a food tray. The second layer 204 of the food tray could be suitable to form one or more portions of the food tray including one or more of the base plate, the side walls, the fillets, the flat regions, or the like of the food tray. As discussed above, the second layer 204 could be paperboard, including kraft paperboard. The thickness of the second layer 204 may be any of the following values or within an inclusive range between any two of the following values: 0.006 inches, 0.012 inches, 0.018 inches, and 0.024 inches.

At block 1308, the method 1300 can include bonding the first layer 202 to the second layer 204 using a bonding layer, e.g., the first adhesive layer 206, the first polyethylene layer 206, acting as an adhesive to adhere the first layer 202 to the second layer 204 (e.g., substantially adhere the layers 202, 204, indicating that the layers 202, 204 are bonded over 90% or more of the overlapping surface area). In various cases, a ratio of a first thickness of the first layer or of the second layer to a second thickness of the first polyethylene layer is between approximately 240:1 to approximately 6:1 or preferably between approximately 30:1 and approximately 20:1, inclusive (e.g., for combination of two 55 #kraft paperboard layers into a 110 #layered wall construction). In some cases, the bonding layer can be applied multiple times to a surface 216 of the first layer 202 or a surface 218 of the second layer 204 and be formed of multiple sub-layers (e.g., one or more aqueous coating sub-layers, one or more adhesive or polyethylene sub-layers, as discussed above).

In various cases, the method 1300 can further include, at optional block 1310, coating an inner surface of the first layer 202 of the food tray in a barrier layer (e.g., the second polyethylene layer 212). The barrier layer can be capable of contacting food contained within the food tray and prevent moisture or other liquid from leaking out of or permeating into the food tray.

In some instances, the method 1300 can further include, at optional block 1312, coating an outer surface of the second layer 204 of the food tray in a varnish layer 214, including a varnish layer formed from an aqueous coating or aqueous varnish, LDPE, or an LDPE substitute. In some cases, the varnish layer 214 can be applied multiple times to the outer surface of the second layer 204 and be formed of multiple sub-layers (e.g., a primer sub-layer and one or more overlying sub-layers, as discussed above). In some cases, the varnish layer 214—or each sub-layer thereof, individually—can be cured or dried to the outer surface of the second layer 204 (e.g., with forced air or infrared drying).

After appropriate bonding and coating, as applicable, the bonded layers 202, 204 can be collectively cut to shape for a relevant application. For example, as detailed above, the layered wall construction 200 (see FIG. 12) can be cut to shape suitable to be formed into either of the food trays 10, 110.

Thus, the embodiments described above can provide a food tray with improved overall strength for the utilized material or that is capable of preventing moisture or other liquid from leaking out of or permeating into the food tray. In some cases, a food tray can also be beneficially formed from adhered paperboard layers (e.g., with a polyethylene or other bonding layer between two or more paperboard layers of the food tray).

It should be understood that the designations of first, second, third, fourth, etc. for any component, state, or condition described herein may be rearranged in the claims so that they are in chronological order with respect to the claims. Furthermore, it should be understood that any component, state, or condition described herein that does not have a numerical designation may be given a designation of first, second, third, fourth, etc. in the claims if one or more of the specific component, state, or condition are claimed.

The detailed description set forth herein includes several embodiments where each of the embodiments may include several components, features, and/or steps. For the avoidance of doubt, any component, feature, and/or step of one embodiment may be applied, mixed, substituted, matched, and/or combined with one or more components, features, and/or steps of other embodiments. Such resulting embodiments are expressly within the scope of this disclosure.

The words used in the specification are words of description rather than limitation, and it is understood that various changes may be made without departing from the spirit and scope of the disclosure. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A food tray comprising:
a base wall;
a side wall extending up and out from the base wall, a bottom portion of the side wall connecting to the base wall via a first fillet, wherein the side wall extends up and out from the base wall along an arc;
a first flat region extending out from a top portion of the side wall, a first end of the first flat region connecting to the top portion of the side wall via a second fillet, wherein the arc of the side wall transitions to the second fillet; and
a second flat region extending down from a second end of the first flat region,
wherein the base wall includes a first layer and a second layer, the first layer and the second layer are coupled together by a first polyethylene layer, and each of the first layer and the second layer include paperboard.

2. The food tray of claim 1, wherein the paperboard of the first layer and the second layer includes kraft paperboard.

3. The food tray of claim 1, wherein the side wall also includes the first layer and the second layer, coupled together by the first polyethylene layer.

4. The food tray of claim 3, wherein the first flat region, and the second flat region also include the first layer and the second layer, coupled together by the first polyethylene layer.

5. The food tray of claim 1, wherein an inner surface of the base wall, facing toward a food storage space of the food tray, is coated with a second polyethylene layer.

6. The food tray of claim 5, wherein an outer surface of the base wall, facing away from the food storage space, is coated with a varnish layer.

7. The food tray of claim 1, wherein an inner surface of the base wall and the side wall are each coated with a second polyethylene layer.

8. The food tray of claim 6, wherein an outer surface the side wall, facing away from the food storage space, is also coated with the varnish layer.

9. The food tray of claim 1, wherein the first polyethylene layer is approximately 0.0001 inches to approximately 0.0015 inches thick, inclusive.

10. The food tray of claim 1, wherein a ratio of a first thickness of the first layer or the second layer to a second thickness of the first polyethylene layer is between approximately 30:1 and approximately 20:1, inclusive.

11. A food tray comprising:
a unitary tray body that includes:
a base wall;
a side wall extending up and out from the base wall; and
a rim that includes a first region extending at a first end out from a top portion of the side wall; and
a second region extending down from a second end of the first region,
wherein the unitary tray body includes a first layer of paperboard and second layer of paperboard, coupled together with an adhesive layer.

12. The food tray of claim 11, wherein the adhesive layer comprises an aqueous coating applied to a first surface of the first layer and a second surface of the second layer and an adhesive sub-layer between the aqueous coating applied to the first surface of the first layer and the second surface of the second layer.

13. The food tray of claim 11, wherein an inner surface of the unitary tray body, facing toward a food storage space of the food tray, is coated with a barrier layer.

14. The food tray of claim 11, wherein an outer surface of the unitary tray body, facing away from a food storage space of the food tray, is coated with a varnish layer.

15. The food tray of claim 14, wherein the varnish layer includes a primer layer and a plurality of coating layers.

16. A method of manufacturing a food tray, the method comprising:
forming or providing a first layer that includes paperboard;
forming or providing a second layer that includes paperboard; and
forming a unitary tray body by:
coupling the first layer to the second layer using an adhesive layer; and
forming the coupled layers into a base wall, a side wall extending up and out from the base wall, and a rim that includes a first region extending out from a top portion of the side wall and a second region extending down from the first region.

17. The method of claim 16, wherein the paperboard of the first and second layers includes kraft paperboard.

18. The method of claim 16, further comprising:
coating an inner surface of the first layer of the base wall in a second polyethylene layer.

19. The method of claim 16, further comprising:
coating an outer surface of the second layer of the base wall in a varnish layer.

20. The method of claim 16, wherein coupling the first layer to the second layer of the base wall using an adhesive layer comprises applying an aqueous coating to a first surface of the first layer and a second surface of the second layer and coupling an adhesive sub-layer to the first surface of the first layer and the second surface of the second layer.
